(19) United States
(12) Patent Application Publication
(10) Pub. No.: US 2017/0193992 A1
(43) Pub. Date: Jul. 6, 2017

(54) VOICE CONTROL METHOD AND APPARATUS

(71) Applicants: Le Holdings (Beijing) Co., Ltd., Chao Yang District (CN); Le Shi Zhi Xin Electronic Technology (Tianjin) Limited, Binhai New Area (CN)

(72) Inventors: Rui Wang, Binhai New Area (CN); Honggui Cui, Binhai New Area (CN)

(21) Appl. No.: 15/241,417

(22) Filed: Aug. 19, 2016

Related U.S. Application Data
(63) Continuation of application No. PCT/CN2016/089578, filed on Jul. 10, 2016.

(30) Foreign Application Priority Data
Dec. 30, 2015 (CN) 201511031185.3

(51) Int. Cl. G10L 15/22; G06F 3/0484

(52) U.S. Cl. CPC G10L 15/22; G06F 3/04847; G10L 2015/223; G10L 2015/221

(57) ABSTRACT

This patent disclosure relates to the field of communications, and discloses a voice control method and a device thereof. Some embodiments of the present disclosure include the following steps: generating, according to collected voice information, a corresponding instruction for execution, and generating a corresponding graph, where the corresponding graph is used to display a recognition result for the voice information; embedding the generated corresponding graph into a view page, and displaying, in a current human-computer interaction interface, a corresponding graph generated according to most recently collected voice information; and if a gesture sliding operation is detected in the human-computer interaction interface, displaying, in the human-computer interaction interface, a corresponding graph indicated by the gesture sliding operation, and executing a corresponding instruction of the indicated corresponding graph. By using the embodiments of the present disclosure, the human-computer interaction interface is simplified, an operation process is simplified, user operation costs are reduced, and impacts on normal driving of a user during operations are reduced.

### CROSS-REFERENCE TO RELATED APPLICATIONS

The present disclosure is a continuation of PCT application No. PCT/CN2016/089578 submitted on Jul. 10, 2016. The present disclosure claims priority to Chinese Patent Application No. 201511031185.3, filed with the Chinese Patent Office on Dec. 30, 2015, which is incorporated herein by reference in its entirety.

### TECHNICAL FIELD

This patent application relates to the field of communications, and in particular, to voice control technologies.

### BACKGROUND

In a process of implementing the present disclosure, the inventor finds that, in a mobile application market, home pages of traditional intelligent voice recognition products are mainly a stack of content, and interaction is performed mainly by means of dialogues. Handover between a recording state and a standby state is performed mainly by means of clicking a trigger button; and an interface is filled with excessive text information or content operations executed after a semantic recognition. If a user in a vehicular state needs to jump back to the recording state from a voice recognition result page or a semantic execution interface, complex operations need to be performed.

However, the user in a driving state has stricter requirements for information acquisition. Excessive redundant information and an excessively complex interaction interface increase operation costs and operation time of the user, and affect normal proceeding of the driving state, thereby preventing such a user interface from being well applied to vehicle-mounted products.

### SUMMARY

The present disclosure provides a voice control method and an electronic device, so as to simplify a human-computer interaction interface and an operation process, reduce user operation costs, and reduce impacts on normal driving of a user.

According to a first aspect, an implementation manner of the present disclosure provides a voice control method, including the following steps: generating, according to collected voice information, a corresponding instruction for execution, and generating a corresponding graph, where the corresponding graph is used to display a recognition result for the voice information; embedding the generated corresponding graph into a view page, and displaying, in a current human-computer interaction interface, a corresponding graph generated according to most recently collected voice information; and if a gesture sliding operation is detected in the human-computer interaction interface, displaying, in the human-computer interaction interface, a corresponding graph indicated by the gesture sliding operation, and executing a corresponding instruction of the indicated corresponding graph.

According to a second aspect, an embodiment of this disclosure further provides a non-volatile computer storage medium, which stores a computer executable instruction, where the computer executable instruction is used to execute any foregoing voice control method of this disclosure.

According to a third aspect, an embodiment of this disclosure further provides an electronic device, including: at least one processor; and a memory for storing programs executable by the at least one processor, where execution of the instructions by the at least one processor causes the at least one processor to execute any foregoing voice control method of this disclosure.

According to the implementation manners of the present disclosure with respect to the prior art, by collecting voice information and recognizing the voice information, a corresponding instruction for execution is generated and a corresponding graph of a recognition result for the voice information is displayed; the corresponding graph is embedded into a view page; and a corresponding graph generated according to most recently collected voice information can be displayed in a human-computer interaction interface; and if a gesture sliding operation is detected in the human-computer interaction interface, a graph corresponding to the gesture sliding is displayed in the human-computer interaction interface, and a corresponding instruction of the indicated graph is executed. An acceleration sliding effect generated by screen sliding among operations on the human-computer interaction interface is used to determine a relative displacement distance of the interface, so as to execute different responses, thereby simplifying an operation process of a user and reducing impacts on normal driving of the user during operations on a vehicle-mounted device.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a voice control method according to some implementation manners of the present disclosure;

FIG. 2 is a schematic diagram of a human-computer interaction interface according to some implementation manners, a second implementation manner, and a third implementation manner of the present disclosure;

FIG. 3 is a schematic diagram of corresponding graph handover when a sliding direction of a gesture sliding operation is from left to right according to some implementation manners of the present disclosure;

FIG. 4 is a schematic diagram of handing over a displayed graph to graph A according to a gesture sliding operation according to some implementation manners of the present disclosure;

FIG. 5 is a system structural diagram of a voice control device according to some implementation manners of the present disclosure; and

FIG. 6 is a schematic structural diagram of an electronic device of some implementation manners of this disclosure.

### DETAILED DESCRIPTION

To make the objectives, technical solutions, and advantages of the present disclosure more clear, the implementation manners of the present disclosure are described below in details with reference to the accompanying drawings. However, a person of ordinary skill in the art can understand that in each implementation manner of the present disclosure, a lot of technical details are provided to make readers better understand this application. However, even through these technical details do not exist, based on the following various variations and modifications to each implementation manner, the technical solutions claimed in the claims of this application can also be implemented.

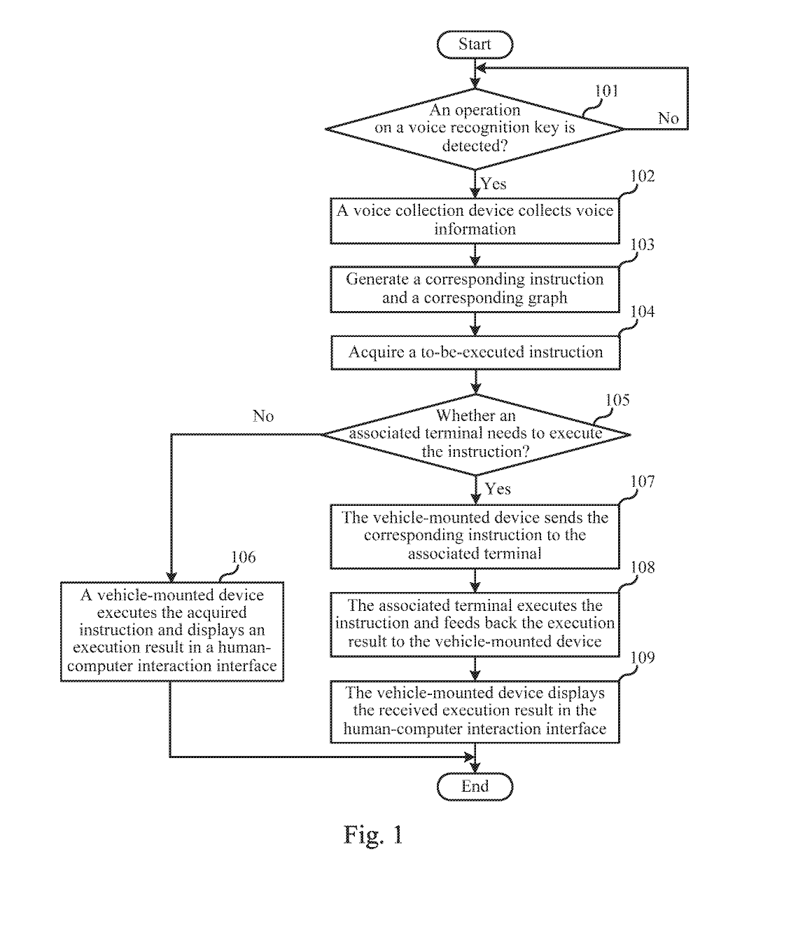

A first implementation manner of the present disclosure relates to a voice control method, and the implementation manner is applied to a vehicle-mounted device. A specific flow is shown in FIG. 1.

In step 101, determine whether an operation on a voice recognition key is detected. Specifically, a key for triggering a voice recognition function is preset in a human-computer interaction interface (for example, a touchscreen) of a vehicle-mounted device. If an operation of a user on the key is not detected, return to an initial state to continue to detect whether the user operates the key for triggering the voice recognition function.

If an operation on the key is detected (for example, it is detected that the key is clicked), proceed to step 102: the vehicle-mounted device collects voice information by using a voice collection device, for example, voice information is collected by using a microphone provided on the vehicle-mounted device.

In the present implementation manner, considering the flexibility and randomness of actual operations of the user, the key for triggering the voice recognition function is provided. The voice collection device is started to collect voices only when an operation on the key is detected, so as to ensure the correctness and reasonability of a voice information collection process.

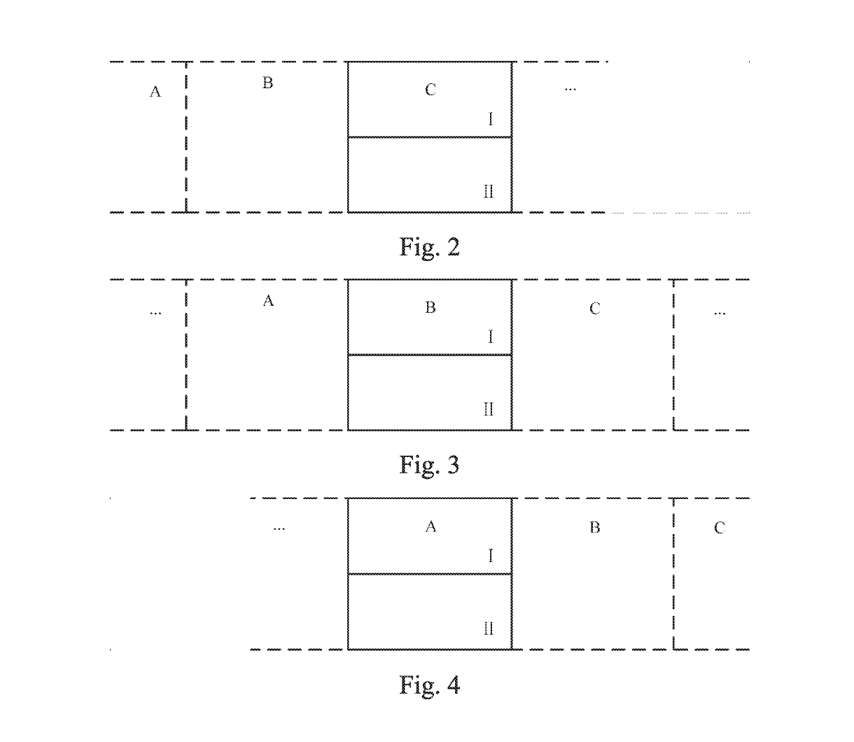

Next, proceed to step 103: generate a corresponding instruction and a corresponding graph. According to the collected voice information, a corresponding instruction for execution and a corresponding graph are generated, where the corresponding graph is used to display a recognition result for the voice information, for example, the graph is text “call Li XX”. Different corresponding graphs are generated by different voice information. Each corresponding graph and corresponding instruction can be stored in the vehicle-mounted device. When a corresponding graph of each piece of voice information is invoked, a corresponding instruction can also be invoked at the same time. Specifically, the various corresponding graphs are embedded side by side into a view page, for example, the various corresponding graphs are embedded side by side into the view page in a sequence from left to right according to a sequence in which corresponding voice information is collected. Moreover, in a current human-computer interaction interface, a corresponding graph generated according to most recently collected voice information is displayed, as shown in FIG. 2. The human-computer interaction interface is represented by a solid-line frame, where C is a corresponding graph displayed in the current human-computer interaction interface; B is a corresponding graph of a previous piece of voice information of the current corresponding graph C; and A is a graph corresponding to a previous piece of voice information of the graph B. Displaying the corresponding graph generated according to latest voice information in the current human-computer interaction interface facilitates the user to intuitively learn the current operation.

For example, an entire human-computer interaction interface (for example, an APP) exists in a form of a view page. When the user initiates a voice information recognition instruction for a single time, a corresponding graph is generated in the voice view page for presenting content of single voice information recognition and semantic understanding. When the user initiates the voice information recognition instruction once again, another corresponding graph is continued to be generated. In this way, various initiated voice information recognition instructions are completed and graphs corresponding thereto are generated. The various corresponding graphs are embedded side by side into the view page in the sequence from left to right according to the sequence in which corresponding voice information is collected, which satisfies operating habits of the user.

In the present implementation manner, the human-computer interaction interface is divided into a first display region and a second display region; the corresponding graph is displayed in the first display region; and the execution result is displayed in the second display region. As shown in FIG. 2, the human-computer interaction interface is represented by a solid-line frame, where an upper end region I is the first display region for displaying the corresponding graph; and a lower end region II is the second display region for displaying the execution result. Dividing the human-computer interaction interface into two regions, and displaying corresponding content in each region simplify a style of the human-computer interaction interface, reduce display information on the human-computer interaction interface, and remove redundant information, so that content on the human-computer interaction interface can be grasped at a glance; and especially, when the foregoing method is applied to the vehicle-mounted device, the user can quickly acquire information, and impacts on driving can be reduced as much as possible.

Next, proceed to step 104: acquire a to-be-executed instruction. Generally, acquiring an instruction for execution has the following two cases:

I. the vehicle-mounted device uses an instruction corresponding to the latest voice information displayed in the current human-computer interaction interface as the to-be-executed instruction; and

II. the instruction for execution is acquired by sliding the human-computer interaction interface using a gesture. Because the corresponding graphs and corresponding instructions that are generated by previous voice information operations are stored in the vehicle-mounted device, to improve user experience and facilitate user operations, the user can slide the human-computer interaction interface using a gesture so as to acquire needed instruction from the vehicle-mounted device. If a gesture sliding operation is detected in the human-computer interaction interface, the corresponding graph indicated by the gesture sliding operation is displayed in the human-computer interaction interface, and the corresponding instruction of the corresponding graph is used as the to-be-executed instruction.

Specifically, when the user horizontally slides on the human-computer interaction interface using gesture operations, a graph on the left or right of the currently displayed graph can be handed over and a corresponding instruction can be invoked. As shown in FIG. 3, when the user slides the human-computer interaction interface from left to right, the graph B corresponding to the previous piece of voice information can be handed over from the graph C, where the human-computer interaction interface is represented by a solid-line frame. Moreover, after the handover is completed, the graph displayed in the human-computer interaction interface is the graph B. In this case, if the user continues sliding the human-computer interaction interface from left to right, the graph B is handed over to the graph A corresponding to a piece of voice information previous to the graph B, as shown in FIG. 4. Correspondingly, when the user slides the human-computer interaction interface from right to left, the graph A can be handed over again to the graph B corresponding to a next piece of voice information of the graph A. The user may complete the handover of the voice information instruction by sliding the human-computer interaction interface using gestures, thereby simplifying the user operation process. In this step, the to-be-executed instruction acquired by the vehicle-mounted device is an instruction corresponding to the graph that is currently displayed in the human-computer interaction interface when the user stops the gesture sliding operation.

Next, proceed to step 105: determine whether the associated terminal needs to execute the instruction. If the determination result is that the associated terminal does not need to execute the instruction, proceed to step 106: the vehicle-mounted device executes the acquired instruction and displays the execution result in the human-computer interaction interface.

If the associated terminal needs to execute the instruction, that is, the determination result is that the associated terminal needs to execute the instruction, proceed to step 107: the vehicle-mounted device sends the corresponding instruction to the associated terminal. The associated terminal may be a mobile phone that may be associated with the vehicle-mounted device by means of Bluetooth pairing. In this step, the vehicle-mounted device can send the instruction to the mobile phone via Bluetooth.

Next, proceed to step 108: the associated terminal executes the instruction and feeds back the execution result to the vehicle-mounted device. The user not only can execute the instruction (for example, make a phone call) by using the terminal, but also can execute the instruction by using the vehicle-mounted device, and the flexibility is high. In a driving process, it is convenient for the user to make reasonable selections according to actual conditions.

Next, proceed to step 109: the vehicle-mounted device displays the received execution result in the human-computer interaction interface so as to facilitate the user to view the currently executed operation.

It is not difficult to find that in the present implementation manner, by collecting voice information and generating a corresponding instruction and a corresponding graph, the generated corresponding graph is embedded into a view page, and a corresponding graph generated according to most recently collected voice information is displayed in a current human-computer interaction interface. In addition, operating the human-computer interaction interface in a sliding manner according to gestures implements the handover and selection of the voice information instruction. An acceleration sliding effect generated by screen sliding among operations on the human-computer interaction interface is used to determine a relative displacement distance of the interface, so as to execute different responses, thereby simplifying an operation process of a user and reducing impacts on normal driving of the user during operations on a vehicle-mounted device.

A second implementation manner of the present disclosure relates to a voice control method. Improvements are made in the second implementation manner based on the first implementation manner, and the main improvement is that a background color of a first display region is different from that of a second display region. For example, the background color of the first display region is black and the background color of the second display region is white; the two regions use the distinct background colors: black and white respectively, so that a boundary therebetween is clear. In this way, the user can quickly locate a region location of needed information directly according to the background color, thereby shortening time for the user to locate a region in which needed information is located.

A third implementation manner of the present disclosure relates to a voice control method. Improvements are made in the third implementation manner based on the first and the second implementation manners, and the main improvement is that areas of the first display region and the second display region are adjustable; and if an area adjusting operation for the first display region or the second display region is received, region area adjustment is performed according to the received area adjusting operation. In an actual operation process, the user can manually drag a frame of the first display region or the second display region until to a proper position, where the heights of the two display regions change with the dragging of the user, so as to adjust display scales of the two display regions in the human-computer interaction interface. The user can flexibly and reasonably adjust, according to viewing habits, the areas of the display regions so as to satisfy viewing requirements of different users.

The step divisions of the foregoing various methods are only for description clearness, and in implementation, the steps can be combined into one step, or some steps can be decomposed into multiple steps for each; as long as the steps include the same logic relationship, the steps are within the protection scope of the present patent; adding insignificant modifications or introducing insignificant designs into an algorithm or a process does not change core designs of the algorithm or process, where the core designs of the algorithm or process are within the protection scope of the patent.

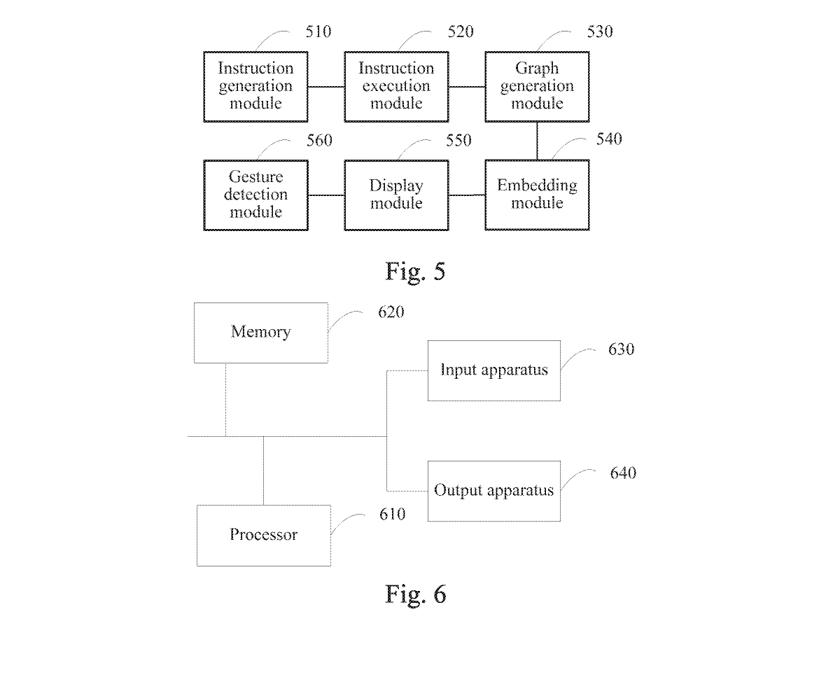

A fourth implementation manner of the present disclosure relates to a voice control device, as shown in FIG. 5, including: an instruction generation module 510, configured to generate a corresponding instruction according to collected voice information; an instruction execution module 520, configured to execute the corresponding instruction generated by the instruction generation module 510; a graph generation module 530, configured to generate a corresponding graph according to the collected voice information, where the corresponding graph is used to display a recognition result for the voice information; an embedding module 540, configured to embed the generated corresponding graph into a view page; a display module 550, configured to display, in the current human-computer interaction interface, a corresponding graph generated according to most recently collected voice information; and a gesture detection module 560, configured to detect whether there is a gesture sliding operation in the human-computer interaction interface, where when the gesture sliding operation is detected by the gesture detection module 560, the display module 550 is triggered to display, in the human-computer interaction interface, a corresponding graph indicated by the gesture sliding operation, and the instruction execution module 520 is triggered to execute a corresponding instruction of the indicated corresponding graph.

It is not difficult to find that the present implementation manner is a device embodiment corresponding to the first implementation manner. The present implementation manner can be implemented in cooperation with the first implementation manner. Relevant technical details mentioned in the first implementation manner are still effective in the present implementation manner. To reduce repetition, details are not described herein again. Correspondingly, relevant technical details mentioned in the present implementation manner can also be applied in the first implementation manner.

It is worth mentioning that the modules involved in the present implementation manner are all logic modules. In actual application, a logic unit may be a physical unit, or may also be a part of a physical unit, or may further be implemented by using a combination of multiple physical units. In addition, to highlight an innovative part of the present disclosure, the present implementation manner does not introduce units that are not closely related to resolving the technical problem proposed in the present disclosure. However, it does not indicate that other units do not exist in the present implementation manner.

A fifth implementation manner of this disclosure provides a non-volatile computer storage medium, which stores a computer executable instruction, where the computer executable instruction can execute the voice control method in any one of the foregoing method embodiments.

A sixth implementation manner of this disclosure relates to an electronic device of a voice control method, and a schematic structural diagram of hardware of the electronic device is shown in FIG. 6, where the device includes:

one or more processors 610 and a memory 620, where only one processor 610 is used as an example in FIG. 6.

A device for executing the voice control method may further include: an input apparatus 630 and an output apparatus 640.

The processor 610, the memory 620, the input apparatus 630, and the output apparatus 640 can be connected by means of a bus or in other manners. A connection by means of a bus is used as an example in FIG. 6.

As a non-volatile computer readable storage medium, the memory 620 can be used to store non-volatile software programs, non-volatile computer executable programs and modules, for example, a program instruction/module corresponding to the voice control method in the embodiments of this disclosure (for example, the instruction generation module 510, the instruction execution module 520, the graph generation module 530, the embedding module 540, the display module 550, and the gesture detection module 560 shown in FIG. 5). The processor 610 executes various functional applications and data processing of the server, that is, implements the voice control method of the foregoing method embodiments, by running the non-volatile software programs, instructions, and modules that are stored in the memory 620.

The memory 620 may include a program storage area and a data storage area, where the program storage area may store an operating system and an application that is needed by at least one function; the data storage area may store data created according to use of the processing apparatus of voice control, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the processing apparatus of voice control. Examples of the foregoing network include but are not limited to: the Internet, an intranet, a local area network, a mobile communications network, or a combination thereof.

The input apparatus 630 can receive entered digits or character information, and generate key signal inputs relevant to user setting and functional control of the processing apparatus of voice control. The output apparatus 640 may include a display device, for example, a display screen.

The one or more modules are stored in the memory 620; when the one or more modules are executed by the one or more processors 610, the voice control method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications;

terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A voice control method, applied in a terminal, comprising the following steps:
generating, according to collected voice information, a corresponding instruction for execution, and generating a corresponding graph, wherein the corresponding graph is used to display a recognition result for the voice information;
embedding the generated corresponding graph into a view page, and displaying, in a current human-computer interaction interface, a corresponding graph generated according to most recently collected voice information; and
if a gesture sliding operation is detected in the human-computer interaction interface, displaying, in the human-computer interaction interface, a corresponding graph indicated by the gesture sliding operation, and executing a corresponding instruction of the indicated corresponding graph.

2. The voice control method according to claim 1, wherein
the different corresponding graphs are generated by different voice information;
the various corresponding graphs are embedded side by side into the view page; and
in the step of displaying, in the human-computer interaction interface, the corresponding graph indicated by the gesture sliding operation, a corresponding graph on the left or right of a currently displayed corresponding graph is displayed according to a sliding direction of the gesture sliding operation.

3. The voice control method according to claim 2, wherein
the various corresponding graphs are embedded side by side into the view page in a sequence from left to right according to a sequence in which corresponding voice information is collected.

4. The voice control method according to claim 1, wherein the voice control method is applied to a vehicle-mounted device.

5. The voice control method according to claim 4, wherein the step of executing a corresponding instruction comprises the following substeps:
sending, by the vehicle-mounted device, the instruction to an associated terminal;
executing, by the associated terminal, the instruction, and feeding back an execution result of the instruction to the vehicle-mounted device; and
displaying, by the vehicle-mounted device, the received execution result in the human-computer interaction interface.

6. The voice control method according to claim 5, wherein the human-computer interaction interface is divided into a first display region and a second display region;
the corresponding graph is displayed in the first display region; and
the execution result is displayed in the second display region.

7. The voice control method according to claim 6, wherein a background color of the first display region is different from that of the second display region.

8. The voice control method according to claim 6, wherein areas of the first display region and the second display region are adjustable; and
if an area adjusting operation for the first display region or the second display region is received, region area adjustment is performed according to the received area adjusting operation.

9. The voice control method according to claim 1, wherein a key for triggering a voice recognition function is preset in the human-computer interaction interface;
before the step of generating, according to collected voice information, a corresponding instruction for execution, further comprising:
if an operation for the key is detected, collecting voices by using a voice collection device.

10. (canceled)

11. A non-volatile computer storage medium, which stores a computer executable instruction that, when executed by an electronic device, cause the electronic device to:
generate, according to collected voice information, a corresponding instruction for execution, and generate a corresponding graph, wherein the corresponding graph is used to display a recognition result for the voice information;
embed the generated corresponding graph into a view page, and display, in a current human-computer interaction interface, a corresponding graph generated according to most recently collected voice information; and
if a gesture sliding operation is detected in the human-computer interaction interface, displaying, in the human-computer interaction interface, a corresponding graph indicated by the gesture sliding operation, and execute a corresponding instruction of the indicated corresponding graph.

12. The non-volatile computer storage medium according to claim 11, wherein
the different corresponding graphs are generated by different voice information;
the various corresponding graphs are embedded side by side into the view page; and
in the step of displaying, in the human-computer interaction interface, the corresponding graph indicated by the gesture sliding operation, a corresponding graph on the left or right of a currently displayed corresponding graph is displayed according to a sliding direction of the gesture sliding operation.

13. The non-volatile computer storage medium according to claim 12, wherein
the various corresponding graphs are embedded side by side into the view page in a sequence from left to right according to a sequence in which corresponding voice information is collected.

14. The non-volatile computer storage medium according to claim 11, wherein the voice control method is applied to a vehicle-mounted device.

15. The non-volatile computer storage medium according to claim 14, wherein the instructions to execute corresponding instructions cause the electronic device to:
send, by the vehicle-mounted device, the instruction to an associated terminal;
execute, by the associated terminal, the instruction, and feeding back an execution result of the instruction to the vehicle-mounted device; and
display, by the vehicle-mounted device, the received execution result in the human-computer interaction interface.

16. An electronic device, comprising:
at least one processor; and
a memory in communication connection with the at least one processor, wherein
the memory stores instructions that can be executed by the at least one processor,
wherein execution of the instructions by the said at least one processor causes the at least one processor to:
generate, according to collected voice information, a corresponding instruction for execution, and generate a corresponding graph, wherein the corresponding graph is used to display a recognition result for the voice information;
embed the generated corresponding graph into a view page, and display, in a current human-computer interaction interface, a corresponding graph generated according to most recently collected voice information; and
if a gesture sliding operation is detected in the human-computer interaction interface, displaying, in the human-computer interaction interface, a corresponding graph indicated by the gesture sliding operation, and executing a corresponding instruction of the indicated corresponding graph.

17. The electronic device according to claim 16, wherein
the different corresponding graphs are generated by different voice information;
the various corresponding graphs are embedded side by side into the view page; and
in the execution of the instructions to display, in the human-computer interaction interface, the corresponding graph indicated by the gesture sliding operation, a corresponding graph on the left or right of a currently displayed corresponding graph is displayed according to a sliding direction of the gesture sliding operation.

18. The electronic device according to claim 17, wherein
the various corresponding graphs are embedded side by side into the view page in a sequence from left to right according to a sequence in which corresponding voice information is collected.

19. The electronic device according to claim 16, wherein the voice control method is applied to a vehicle-mounted device.

20. The electronic device according to claim 19, wherein the execution of the instructions to execute corresponding instructions cause the at least one processor to:
send, by the vehicle-mounted device, the instruction to an associated terminal;
execute, by the associated terminal, the instruction, and feeding back an execution result of the instruction to the vehicle-mounted device; and
display, by the vehicle-mounted device, the received execution result in the human-computer interaction interface.

21. The electronic device according to claim 20, wherein the human-computer interaction interface is divided into a first display region and a second display region;
the corresponding graph is displayed in the first display region; and
the execution result is displayed in the second display region.
